(19) United States
(12) Patent Application Publication
(10) Pub. No.: US 2021/0336646 A1
(43) Pub. Date: Oct. 28, 2021

(54) SWITCH CONTROL SYSTEM ADAPTABLE FOR ANY USER LOCATION WITHIN RADIO RANGE AND METHOD OF SYSTEM

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: YU-HUNG TSAO, New Taipei (TW); QIU-HONG XIE, Shenzhen (CN)

(21) Appl. No.: 16/924,469

(22) Filed: Jul. 9, 2020

(30) Foreign Application Priority Data
Apr. 24, 2020 (CN) 202010335468.1

(51) Int. Cl. H04B 1/16; H04B 1/04; G06K 7/10

(52) U.S. Cl. CPC H04B 1/1615; G06K 7/10386; H04B 1/0458

(57) ABSTRACT

A switch control system including a switch unit and a control unit allows the switch unit to be disposed at any position within an effective radiation range of the control unit. The switch unit transmits an identifier to the control unit when pressed by a user. The control unit is electrically connected to a functional unit, the control unit is used to transmit radio frequency signals and read the identifier of the switch unit, and turn on or off the functional unit according to the identifier as read. A related method is also provided. The switch unit can be installed at any position within the radiation range and the position can be changed at any time.

### FIELD

The subject matter herein generally relates to power control.

### BACKGROUND

A switch is usually fixed on the wall of a bedroom and connected to lighting devices through a cable to control the lighting. As shown in FIG. 1, the switch S1 in the prior art is fixed on the wall W1 and is electrically connected to the electric bulb P1 through the electric cable L1. Therefore, when the user needs to reposition the switch S1, the wall must be demolished, causing unnecessary loss. In addition, because the switch is fixed on the wall, when the electric bulb needs to be turned on or off, it is inconvenient for someone in bed, for example, to reach the switch to turn off the light.

Therefore, improvement is desired.

### BRIEF DESCRIPTION OF THE DRAWINGS

Implementations of the present disclosure will now be described, by way of embodiments, with reference to the attached figures.

FIG. 1 is a schematic diagram of a connection between a switch and an electric bulb in the prior art.

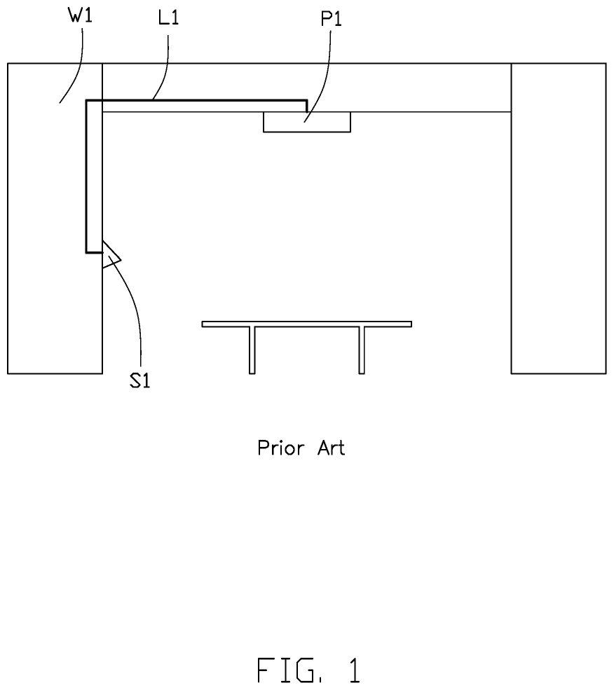

FIG. 2 is a block diagram of an embodiment of a switch control system of the present disclosure.

FIG. 3 is a schematic diagram of a first embodiment of the switch control system of FIG. 2.

FIG. 4 is a schematic diagram of an embodiment of a switch unit of the system of FIG. 2.

FIG. 5 is a schematic diagram of the switch unit unpressed.

FIG. 6 is a schematic diagram of the switch unit when pressed.

FIG. 7 is a schematic diagram of an embodiment of a control unit of the system of FIG. 2.

FIG. 8 is a schematic diagram of a second embodiment of the switch control system of FIG. 2.

FIG. 9 is a flowchart of an embodiment of a switch control method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

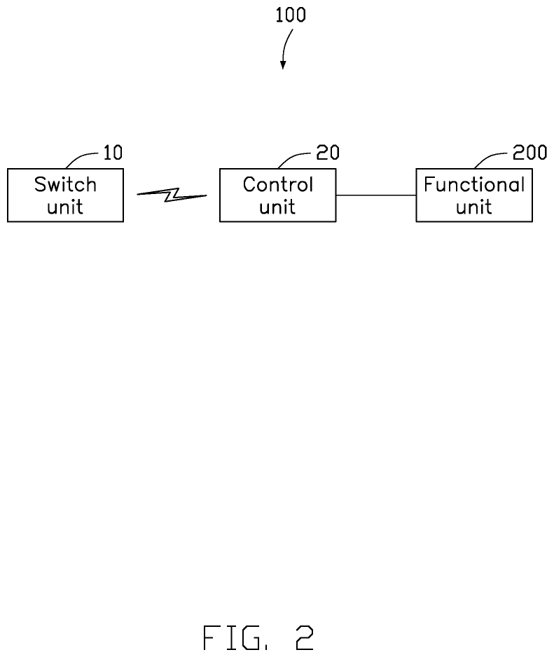

FIG. 2 illustrates a switch control system 100 in accordance with an embodiment of the present disclosure. The switch control system 100 is used to control a functional unit 200, such that the switch control system 100 can turn on or turn off the functional unit 200.

In the embodiment, the functional unit 200 may be an electric light bulb, and the switch control system 100 can turn off or turn on the electric light bulb. In other embodiments, the functional unit 200 may also be other electrical equipment.

In the embodiment, the switch control system 100 includes a switch unit 10 and a control unit 20.

The control unit 20 has a radiation range. The switch unit 10 is disposed on any position within the radiation range of the control unit 20. In the embodiment, a switch is not required to be installed in a fixed position, the position of the switch can be changed at any time according to different needs.

In the embodiment, the switch unit 10 has an identifier. In at least one embodiment, the identifier of the switch unit 10 may be a radio frequency identification (RFID) technology.

The switch unit 10 transmits the identifier to the control unit 20 when triggered. For example, the switch unit 10 can transmit the identifier to the control unit 20 when pressed. The control unit 20 is electrically coupled to the functional unit 200. The control unit 20 is used to transmit radio frequency (RF) signals and to read the identifier of the switch unit 10, and turn on or turn off the functional unit 200 according to the identifier.

In at least one embodiment, the control unit 20 may use RFID technology to transmit radio frequency signals, and receive and demodulate a response of the identifier of the switch unit 10.

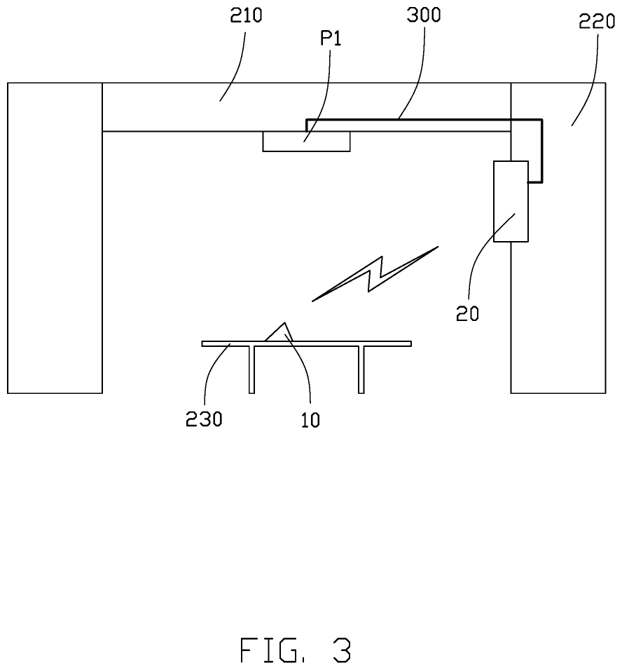

FIG. 3 illustrates the functional unit 200 installed on a ceiling 210 of the room. The control unit 20 is installed on a wall 220. The control unit 20 is electrically coupled to the functional unit 200 through a cable 300. The switch unit 10 is disposed on a bed 230. In the room, the switch unit 10 is within the radiation range of the control unit 20.

If the user needs to control the functional unit 200 at any time, he or she presses the switch unit 10 to conveniently turn on or turn off the functional unit 200.

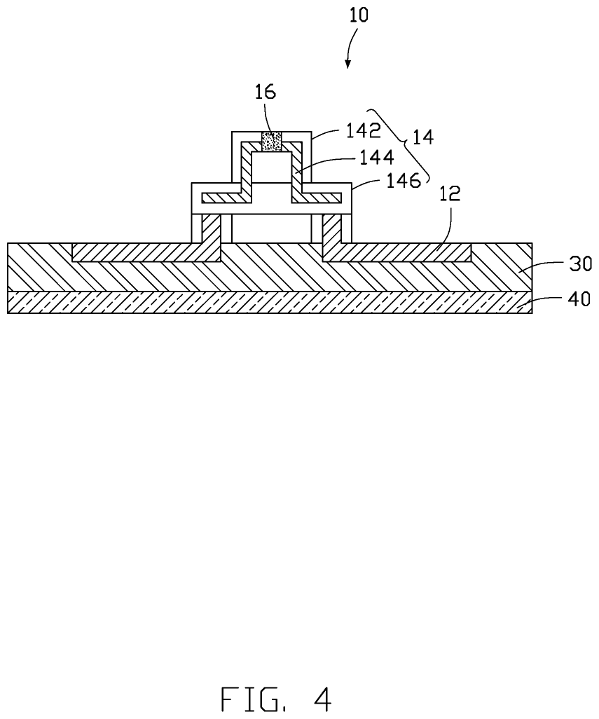

FIG. 4 illustrates that the switch unit 10 includes a first antenna module 12, a switch 14, and a chip module 16.

In the embodiment, the switch unit 10 receives the RF signals through the first antenna module 12. The switch unit 10 transmits the identifier through the first antenna module 12.

In the embodiment, the switch 14 is a button switch. The switch 14 includes a button member 142, a conductive member 144, and a housing 146.

The housing 146 defines a receiving cavity (not shown). The conductive member 144 is disposed in the accommodating cavity and attached to an end of the button member 142.

In at least one embodiment, the conductive member 144 is made of conductive metal material.

In at least one embodiment, the switch control system 100 further includes a support member 30 and a fix member 40.

The support member 30 is used to support the switch unit 10, and the switch 14 and the first antenna module 12 may be fixed on a first side of the support member 30.

In at least one embodiment, the support member 30 may be a printed circuit board (PCB), and the PCB serves as a circuit substrate to support the switch unit 10. In another embodiment, the support member 30 may also be a substrate made of saturated polyester.

The fix member 40 is disposed on a second side of the support member 30, the fix member 40 may fix the switch unit 10 at a preset position, and the preset position may be a frame of a bed or can be on the wall.

In at least one embodiment, the fix member 40 is any one of an adhesive member, a magnetic element, or a fixing device, and needs only to be strong enough to fix the support member 30 and the switch unit 10 to a bed frame, a wall, or other position.

In at least one embodiment, the chip module 16 is electrically connected to the conductive member 144.

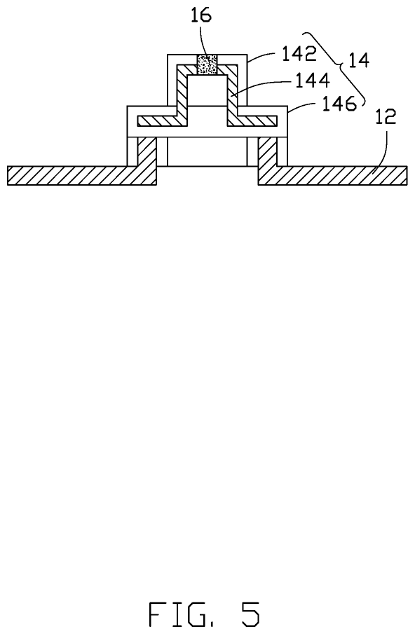

FIG. 5 illustrates a schematic diagram when the button member 142 in the switch unit 10 and is not pressed.

As shown in FIG. 5, when the button member 142 is not pressed, both ends of the first antenna module 12 are disconnected from both ends of the conductive member 144, the first antenna module 12 does not form a complete antenna loop. The first antenna module 12 will not receive RF signals, nor will an identifier be transmitted to the control unit 20.

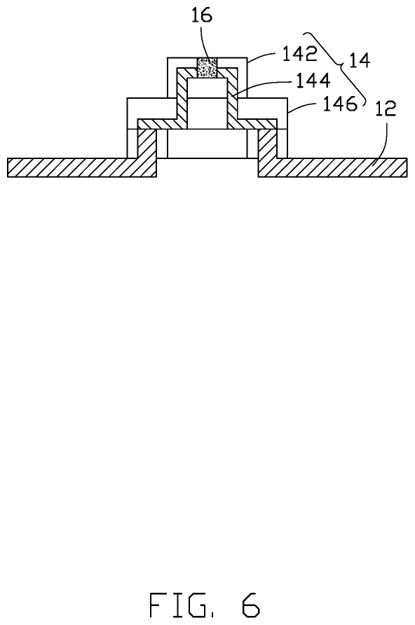

FIG. 6 illustrates a schematic diagram when the button member 142 in the switch unit 10 is pressed.

As shown in FIG. 6, when the button member 142 is pressed, both ends of the conductive member 144 electrically couple the two ends of the first antenna module 12, thereby forming a complete antenna loop. Thus, the first antenna module 12 can receive the RF signals transmitted by the control unit 20, to power for the switch unit 10.

In the embodiment, the chip module 16 stores the identifier. In at least one embodiment, the identifier is unique and marks the identity of the switch unit 10. When the switch 14 is pressed, and the first antenna module 12 forms a loop, the chip module 16 starts to work and transmits the identifier to the control unit 20 through the first antenna module 12.

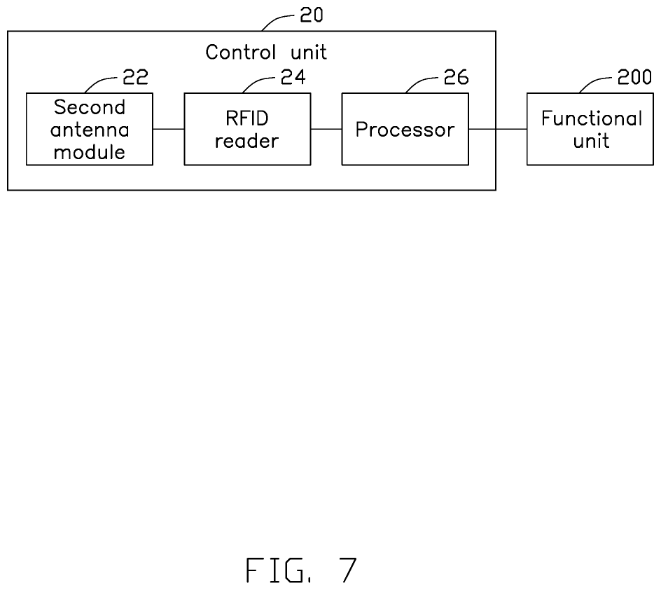

FIG. 7 illustrates that the control unit 20 includes a second antenna module 22, a RFID reader 24, and a processor 26.

In at least one embodiment, the RFID reader 24 is electrically coupled to the second antenna module 22. The second antenna module 22 is electrically coupled to the processor 26. The processor 26 is electrically coupled to the functional unit 200.

In at least one embodiment, the RFID reader 24 is electrically coupled to a power supply module (not shown). The power supply module is equipped with a battery or a supercapacitor to provide power for the control unit 20 to operate. The power supply module can be any form of the power output device to stably provide the power required for the operation of the control unit 20.

In at least one embodiment, the RFID reader 24 transmits the RF signals to the first antenna module 12 through the second antenna module 22, and receives the identifier transmitted by the first antenna module 12 through the second antenna module 22.

The RFID reader 24 reads the identifier of the switch unit 10 through the RFID technology.

In another embodiment, the RFID reader 24 may be another type of wireless tag reader. The wireless tag reader may also read the identifier of the switch unit 10 through other communication methods (such as WIFI and BLUETOOTH).

In at least one embodiment, the RFID reader 24 receives the power supply from the power supply module, transmits a radio frequency signal through the second antenna module 22, and when the switch is pressed, the switch unit 10 can be driven to transmit the identifier. The RFID reader 24 also receives the identifier transmitted by the switch unit 10 through the second antenna module 22 and demodulates the identifier. It can be understood that the second antenna module 22 has a radiation range, and the radiation range is the range of recognition of the control unit 20. When the switch unit 10 enters the reading range of the control unit 20, the radio frequency signal transmitted by the second antenna module 22 can convey the switch unit 10 and can receive all identifiers within the radiation range, the control unit 20 may establish a wireless communication connection with the switch unit 10.

The processor 26 is configured to determine the legality and validity of the identifier response of the switch unit 10 received by the RFID reader 24. The control unit 20 can store a default value.

In at least one embodiment, the processor 26 can be a microcontroller unit (MCU).

The processor 26 compares the identifier response of the switch unit 10 with the default value stored in the control unit 20. When the identifier response of the switch unit 10 matches the default value stored in the control unit 20, the processor 26 determines that the identifier is legal and valid.

When the processor 26 determines that the identifier is legal, it confirms the identity of the control unit 20. Thereby, the processor 26 can control the on or off state of the functional unit 200 according to the identifier received by the RFID reader 24.

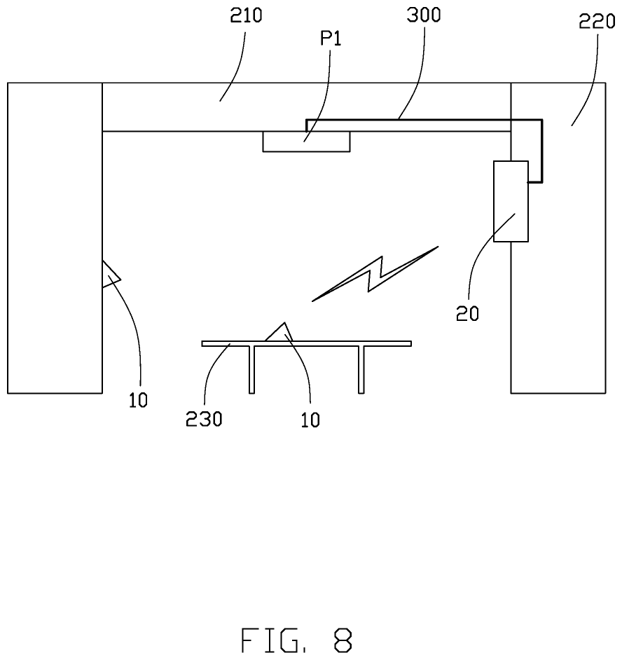

FIG. 8 illustrates a schematic diagram of a second embodiment of the control unit 20 and switch unit 10.

The switch control system in the second embodiment differs from the switch control system in the first embodiment in that:

The switch control system in this embodiment may include a plurality of switch units 10. In the embodiment, only two switch units are shown as an example for description. In other embodiments, the number of the switch units 10 may be greater than 2, and the number of the switch units 10 can be adjusted according to actual needs.

In the embodiment, when the two switch units are within the radiation range, the control unit 20 can establish a wireless communication connection with the two switch units.

In at least one embodiment, the control unit 20 can be fixed at a location (such as a wall) in the room, whereby the user can install the switch unit 10 at any position within the radiation range of the control unit 20 and can change the position at any time according to different needs. The RFID reader 24 transmits the RF signals through the second antenna module 22, when a user needs to turn on the functional unit 200 (such as an electric bulb), he or she presses the switch of the switch unit 10 corresponding to the electric bulb. At this time, the first antenna module 12 can receive the RF signals and be driven, and transmit the identifier to the control unit 20.

The RFID reader 24 receives the identifier transmitted by the switch unit 10 through the second antenna module 22, demodulates the identifier, and transmits the identifier to the processor 26. The processor 26 compares the identifier with the default value to determine the legality of the identifier, thereby controlling the light bulb to turn on.

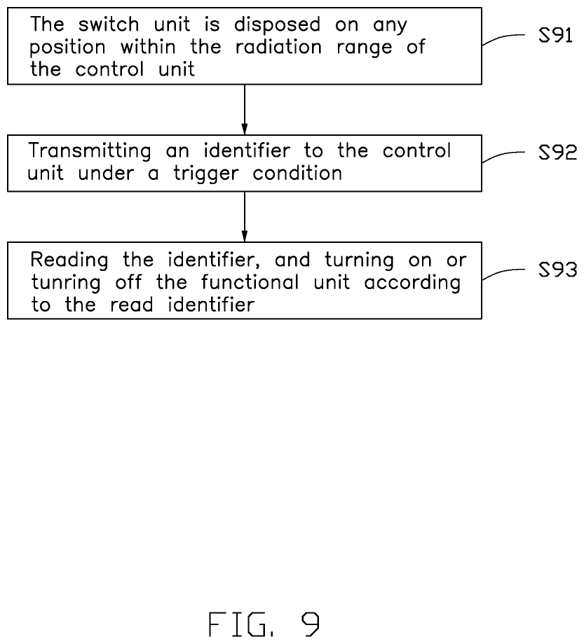

FIG. 9 illustrates a flowchart of a switch control method. The switch control method may include the following steps.

In block S91, the switch unit is disposed on any position within the radiation range of the control unit.

In the embodiment, the control unit 20 has a radiation range. The switch unit 10 is disposed on any position within a radiation range of the control unit 20. In the embodiment, a switch is not required to be installed in a fixed position, the position of the switch can be changed at any time according to different needs.

In block S92, transmitting an identifier to the control unit when triggered.

In the embodiment, the switch unit 10 has an identifier. In at least one embodiment, the identifier of the switch unit 10 may be a radio frequency identification (RFID) technology.

The switch unit 10 transmits the identifier to the control unit 20 under a trigger condition. For example, the switch unit 10 can transmit the identifier to the control unit 20 when pressed.

In block S93, reading the identifier, and turning on or turning off the functional unit according to the read identifier.

The control unit 20 is electrically coupled to the functional unit 200. The control unit 20 is used to transmit radio frequency (RF) signals and read the identifier of the switch unit 10, and turn on or turn off the functional unit 200 according to the identifier.

In at least one embodiment, the control unit 20 may use RFID technology to transmit radio frequency signals, receive and demodulate a response of the identifier of the switch unit 10.

Therefore, the user can conveniently control the on and off of the functional unit 200 (such as an electric bulb) or other functions. In addition, due to the switch unit 10 and the control unit 20 are wirelessly connected, the switch unit 10 can be installed at any position within the radiation range of the control unit 20, and the position can be changed at any time according to different needs, simple and easy to use.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

1. A switch control system comprising:
a control unit electrically coupled to a functional unit; and
a switch unit disposed on any position within a radiation range of the control unit;
wherein the switch unit transmits an identifier to the control unit when triggered;
wherein the control unit transmits radio frequency (RF) signals, reads the identifier of the switch unit, and turns on or turns off the functional unit according to the identifier; and
wherein the switch unit comprises a first antenna module, the first antenna module receives the RF signals transmitted by the control unit, to power for the switch unit;
wherein the switch unit transmits the identifier through the first antenna module, the switch unit comprises a switch, the switch comprises a button member, a conductive member, and a housing, the conductive member is disposed in the housing and attached to an end of the button member.

2-3. (canceled)

4. The switch control system according to claim 1, wherein when the button member is pressed, two ends of the conductive member are respectively electrically coupled to two ends of the first antenna module to form a complete antenna loop.

5. The switch control system according to claim 4, wherein the switch unit further comprises a chip module, the chip module is electrically coupled to the conductive member, the chip module stores the identifier, and the chip module transmits the identifier to the control unit through the first antenna module.

6-10. (canceled)

11. A switch control system comprising:
a control unit electrically coupled to a functional unit; and
a switch unit disposed on any position within a radiation range of the control unit;
wherein the switch unit transmits an identifier to the control unit when triggered;
wherein the control unit transmits radio frequency (RF) signals, reads the identifier of the switch unit, and turns on or turns off the functional unit according to the identifier;
wherein the control unit comprises a wireless tag reader, a second antenna module, and a processor, the wireless tag reader is electrically coupled to the second antenna module, the wireless tag reader transmits the RF signals through the second antenna module, and receives the identifier of the switch unit through the second antenna module;
wherein the wireless tag reader is a radio frequency identification (RFID) reader, and the wireless tag reader reads the identifier of the switch unit through the RFID technology;
wherein the processor is electrically coupled to the wireless tag reader and the functional unit, the processor turns on or turns off the functional unit according to the identifier received by the wireless tag reader; and
wherein the switch unit comprises a first antenna module, the first antenna module receives the RF signals transmitted by the control unit, to power for the switch unit;
wherein the switch unit transmits the identifier through the first antenna module, the switch unit comprises a switch, the switch comprises a button member, a conductive member, and a housing, the conductive member is disposed in the housing and attached to an end of the button member.

12-13. (canceled)

14. The switch control system according to claim 11, wherein when the button member is pressed, two ends of the conductive member are respectively electrically coupled to two ends of the first antenna module to form a complete antenna loop.

15. The switch control system according to claim 14, wherein the switch unit further comprises a chip module, the chip module is electrically coupled to the conductive member, the chip module stores the identifier, and the chip module transmits the identifier to the control unit through the first antenna module.

16-18. (canceled)
